(19) United States
(12) Patent Application Publication
(10) Pub. No.: US 2026/0093505 A1
(43) Pub. Date: Apr. 2, 2026

(54) PROVIDING FEEDBACK BASED ON USER INPUT

(71) Applicant: Apple Inc., Cupertino, CA (US)

(72) Inventors: Evan JONES, Kirkland, WA (US); Guilherme KLINK, Campbell, CA (US); Tigran KHACHATRYAN, North Hills, CA (US)

(21) Appl. No.: 19/324,923

(22) Filed: Sep. 10, 2025

Related U.S. Application Data
(60) Provisional application No. 63/700,666, filed on Sep. 28, 2024.

(51) Int. Cl. G06F 9/451; G06F 3/01

(52) U.S. Cl. CPC G06F 9/451; G06F 3/017

(57) ABSTRACT

Feedback can be displayed based on input at an electronic device in communication with one or more displays and one or more input devices. The input, including a gesture, can be detected via the one or more input devices. The feedback can be presented based on a characteristic of the gesture while detecting the input in accordance with a determination that the input satisfies one or more first criteria. The feedback can include an animated effect. The animated effect can be displayed with a first visual characteristic in accordance with a determination that a measure of the characteristic of the gesture satisfies one or more second criteria, different from the one or more first criteria.

### CROSS-REFERENCE TO RELATED APPLICATIONS

This application claims the benefit of U.S. Provisional Application No. 63/700,666, filed Sep. 28, 2024, the content of which is herein incorporated by reference in its entirety for all purposes.

### FIELD OF THE DISCLOSURE

This relates generally to systems and methods for providing feedback based on input from a user.

### BACKGROUND OF THE DISCLOSURE

Some systems and devices provide computer-generated environments (e.g., extended reality environments, augmented reality environments, mixed reality environments, virtual reality environments, etc.) including two-dimensional and/or three-dimensional environments in which objects such as virtual objects, graphical interface elements, user interface elements, etc. are displayed.

### SUMMARY OF THE DISCLOSURE

Some examples of the disclosure are directed to systems and methods for detecting input and presenting feedback at an electronic device in communication with one or more displays and one or more input devices. The feedback can facilitate effective operation by the user and an improved user experience. In some examples, the electronic device can be configured to detect the input, including a gesture directed at an object in a three-dimensional environment. In some examples, the electronic device can be configured to present the feedback in the three-dimensional environment in accordance with a determination that the input satisfies one or more first criteria. In some examples, the electronic device can be configured to present the feedback, including an animated effect based on a characteristic of the gesture, in which progress of the animated effect indicates progress of the characteristic of the gesture.

Some examples of the disclosure are directed to systems and methods for detecting input and presenting feedback at an electronic device in communication with one or more displays and one or more input devices. In some examples, the electronic device can be configured to detect the input, including a gesture directed at an object. In some examples, the electronic device can be configured to present the feedback in a three-dimensional environment in accordance with a determination that the input satisfies one or more first criteria. In some examples, the electronic device can be configured to present the feedback, including a user interface element, in which the user interface element includes information associated with the object. Dismissing the user interface element can be based on the timing of the presentation of the user interface element and/or the duration that the input is held (e.g., while displaying the user interface element). In some examples, in accordance with a determination that the input including the gesture satisfies one or more second criteria, the electronic device can be configured to terminate the display of the user interface element in accordance with termination of the input including the gesture. In accordance with a determination that the input including the gesture fails to satisfy the one or more second criteria, the electronic device can terminate the display of the user interface element in accordance with a predetermined time period.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following Drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3C illustrate an example of operation of an electronic device including presenting feedback based on input directed at an object in a three-dimensional environment according to some examples of the disclosure.

FIGS. 4A-4C illustrate another example of operation of an electronic device including presenting feedback based on input directed at an object in a three-dimensional environment according to some examples of the disclosure.

FIGS. 5A-5C illustrate another example of operation of an electronic device including presenting feedback based on input directed at an object in a three-dimensional environment according to some examples of the disclosure.

FIGS. 6A-6C illustrate another example of operation of an electronic device including presenting feedback based on input directed at an object in a three-dimensional environment according to some examples of the disclosure.

FIGS. 7A-7B illustrate another example of operation of an electronic device including presenting feedback based on input directed at an object in a three-dimensional environment according to some examples of the disclosure.

FIG. 8 is a flow chart illustrating an example method for presenting feedback based on input directed at an object in a three-dimensional environment according to some examples of the disclosure.

FIG. 9 is a flow chart illustrating an example method for presenting and terminating a user interface element based on input directed at an object in a three-dimensional environment according to some examples of the disclosure.

### DETAILED DESCRIPTION

Some examples of the disclosure are directed to systems and methods for detecting input and presenting feedback at an electronic device in communication with one or more displays and one or more input devices. The feedback can facilitate effective operation by the user and an improved user experience. In some examples, the electronic device can be configured to detect the input, including a gesture directed at an object in a three-dimensional environment. In some examples, the electronic device can be configured to present the feedback in the three-dimensional environment in accordance with a determination that the input satisfies one or more first criteria. In some examples, the electronic device can be configured to present the feedback, including an animated effect based on a characteristic of the gesture, in which progress of the animated effect indicates progress of the characteristic of the gesture.

Some examples of the disclosure are directed to systems and methods for detecting input and presenting feedback at an electronic device in communication with one or more displays and one or more input devices. In some examples, the electronic device can be configured to detect the input, including a gesture directed at an object. In some examples, the electronic device can be configured to present the feedback in a three-dimensional environment in accordance with a determination that the input satisfies one or more first criteria. In some examples, the electronic device can be configured to present the feedback, including a user interface element, in which the user interface element includes information associated with the object. Dismissing the user interface element can be based on the timing of the presentation of the user interface element and/or the duration that the input is held (e.g., while displaying the user interface element). In some examples, in accordance with a determination that the input including the gesture satisfies one or more second criteria, the electronic device can be configured to terminate the display of the user interface element in accordance with termination of the input including the gesture. In accordance with a determination that the input including the gesture fails to satisfy the one or more second criteria, the electronic device can terminate the display of the user interface element in accordance with a predetermined time period.

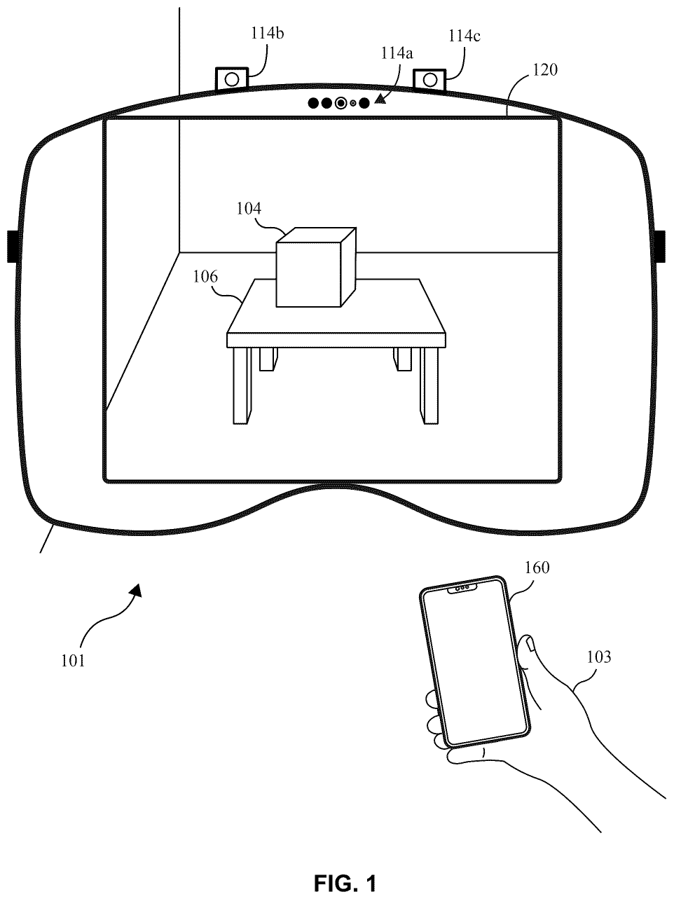

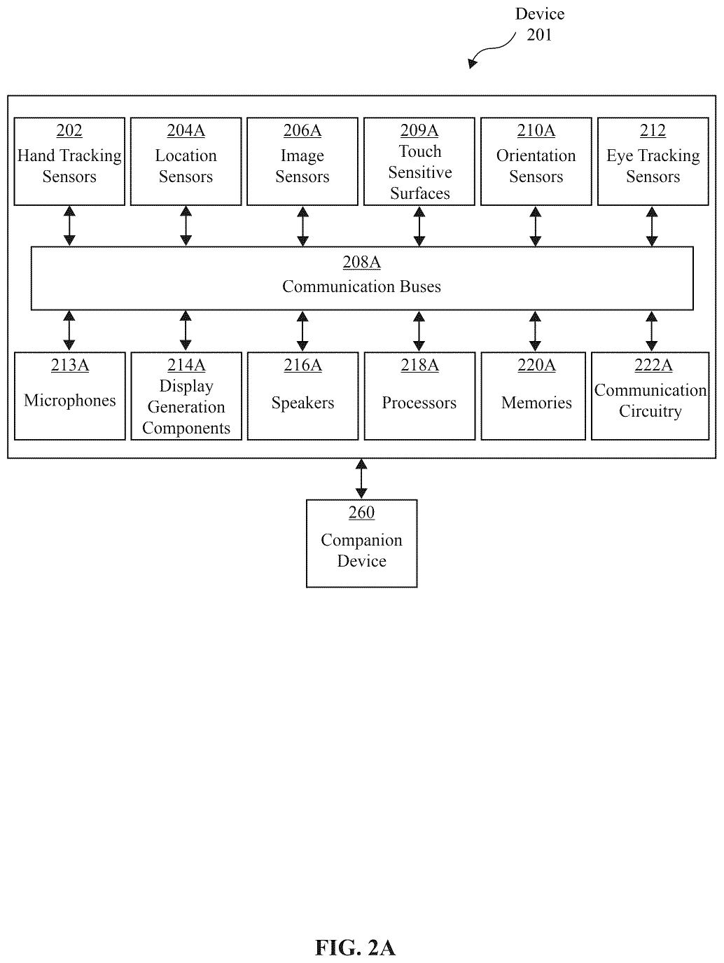

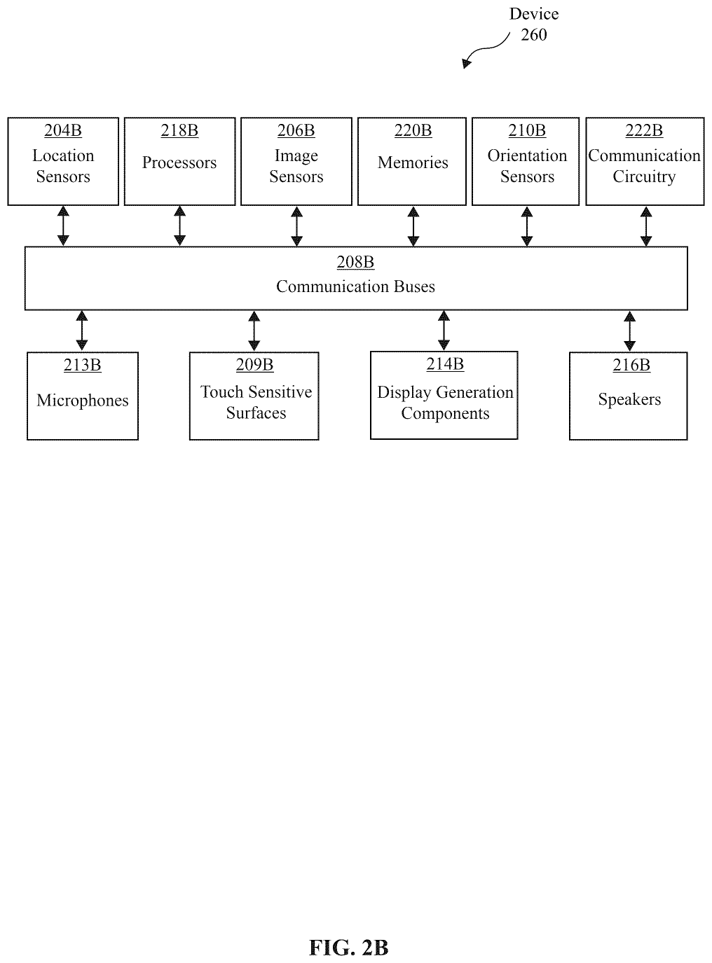

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards the various descriptions of systems and methods for detecting input and presenting feedback at an electronic device (e.g., electronic device 101, electronic device 201, etc.) in communication with one or more displays and one or more input devices. In some examples, the electronic device is located in a physical environment and is configured to detect input (e.g., input including a gesture directed at an object, such as a physical object in the physical environment, or a virtual object) and present feedback (e.g., feedback based on the input including the gesture) in a three-dimensional environment (e.g., corresponding to a physical environment).

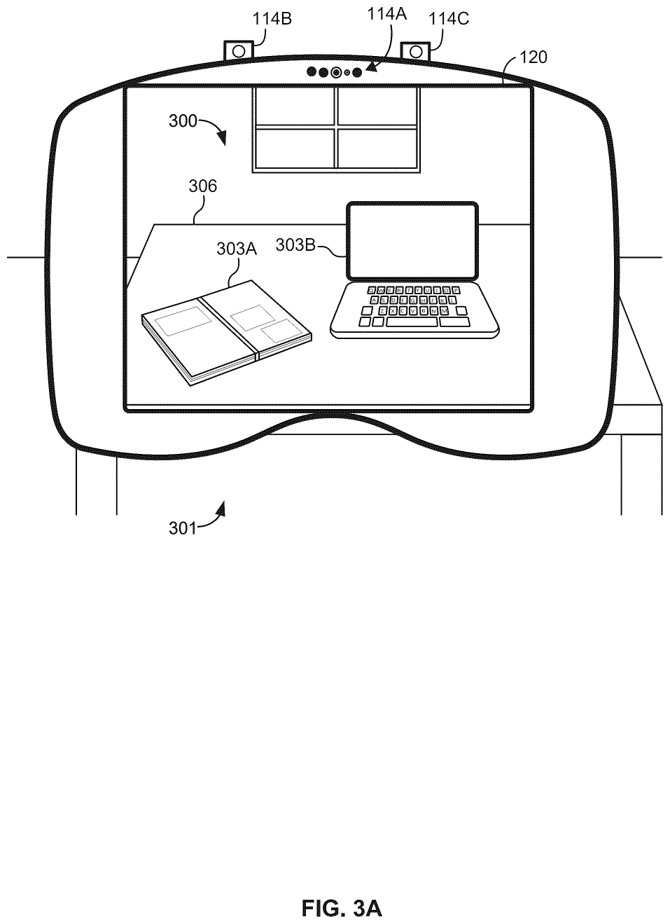

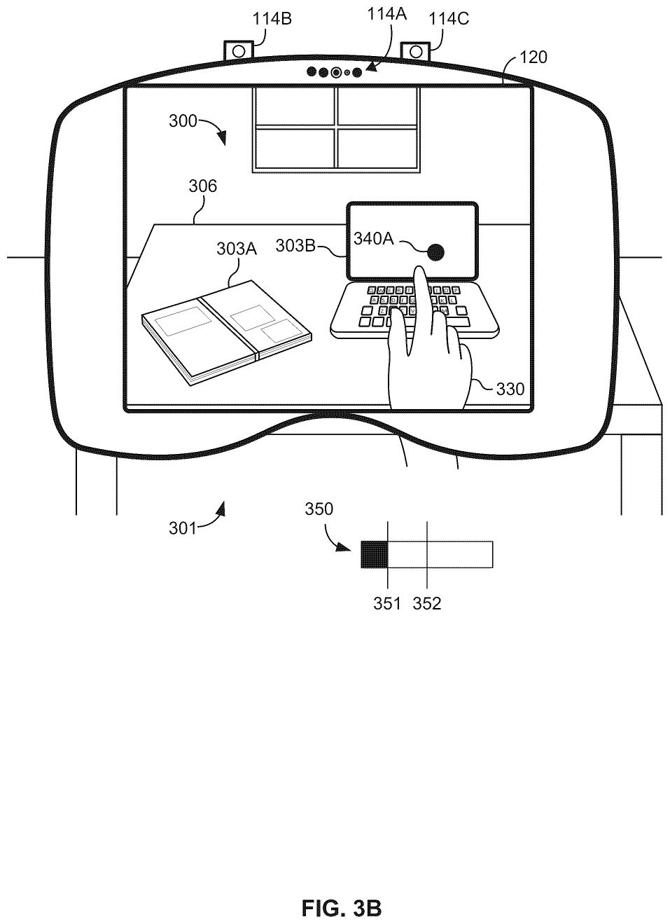

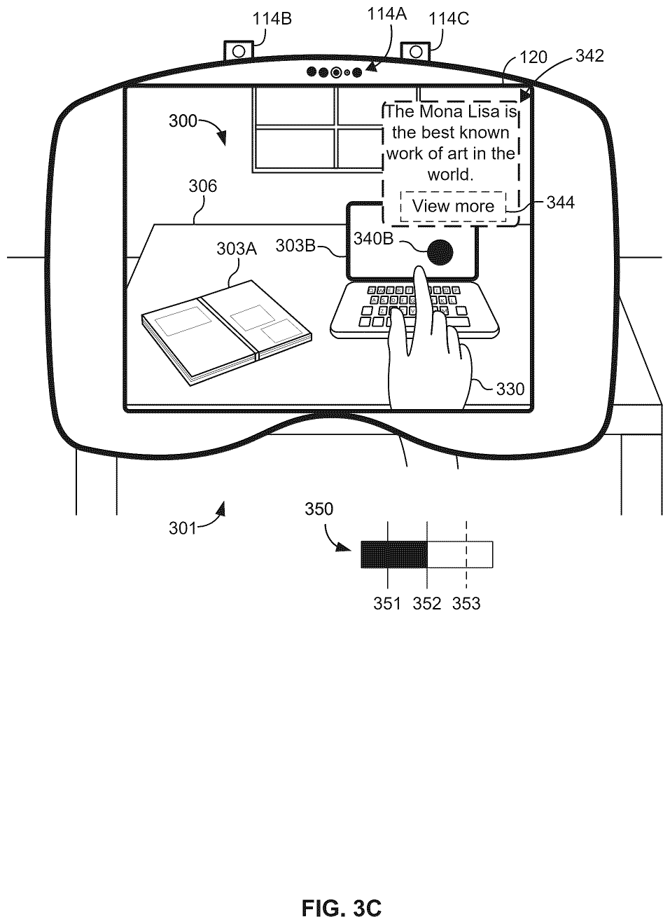

FIGS. 3A-3C illustrate an example of operation of an electronic device including presenting feedback based on input directed at an object in a three-dimensional environment according to some examples of the disclosure. As shown, FIGS. 3A-3C illustrate electronic device 301 in a physical environment while presenting a three-dimensional environment 300, as described herein. Electronic device 301 can include an electronic device such as electronic device 101 and/or electronic device 201, as described with reference to FIG. 1 and/or FIG. 2. For example, electronic device 301 can include one or more input devices (e.g., hand tracking sensors 202, location sensors 204, image sensors 206, internal image sensors 114a and/or external image sensors 114b and 114c, touch-sensitive surfaces 209, motion and/or orientation sensors 210, eye tracking sensors 212, microphones 213 or other audio sensors, body tracking sensors, etc.) and one or more output devices (e.g., display 120, display generation components 214, etc.), as described herein. The physical environment can include a physical environment (e.g., in which electronic device 301 is located) such as the physical environment shown and described with reference to FIG. 1. For example, the physical environment can include objects such as table 306, object 303A, and/or object 303B, such as shown in FIGS. 3A-3C. Three-dimensional environment 300 optionally has one or more characteristics of the three-dimensional environment described with reference to FIG. 1.

With reference to FIG. 3A, electronic device 301 presents (e.g., via one or more displays) three-dimensional environment 300 for viewing by a user in connection with the user's view of a physical environment. For example, electronic device 301 can be configured to present three-dimensional environment 300 for viewing by the user from a viewpoint located and oriented at a position and/or orientation in the physical environment. From this position and/or orientation the user's field of view includes objects such as table 306, object 303A, object 303B, and/or the like, as shown in FIGS. 3A-3C. FIG. 3A represents three-dimensional environment 300 prior to detecting input (e.g., a hand or finger gesture).

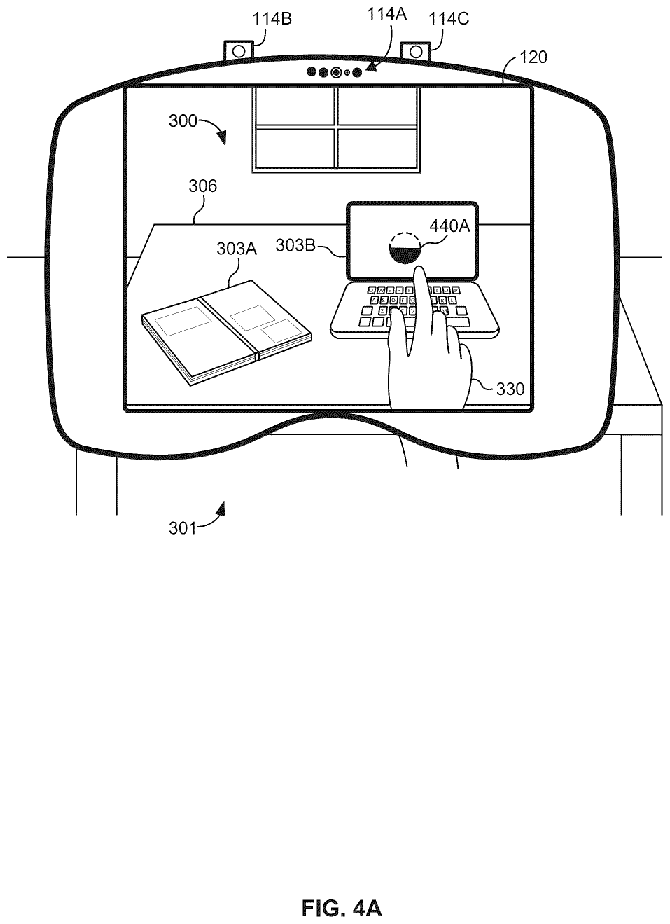

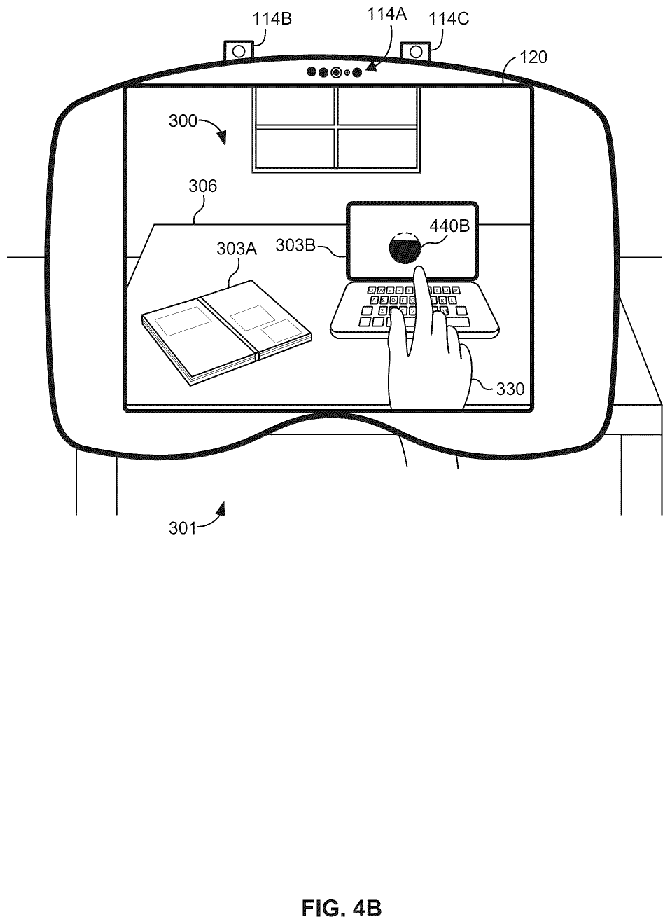

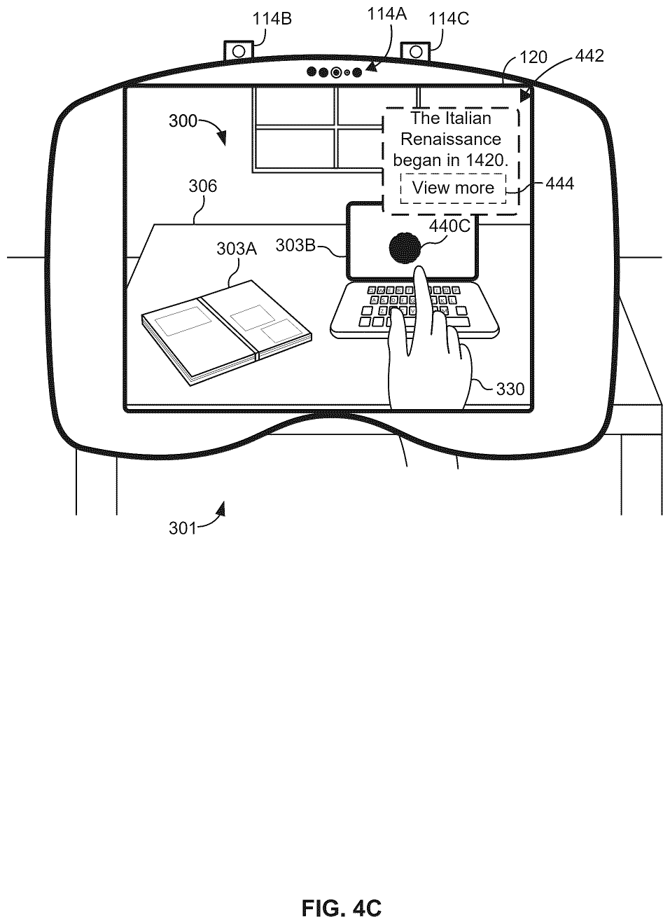

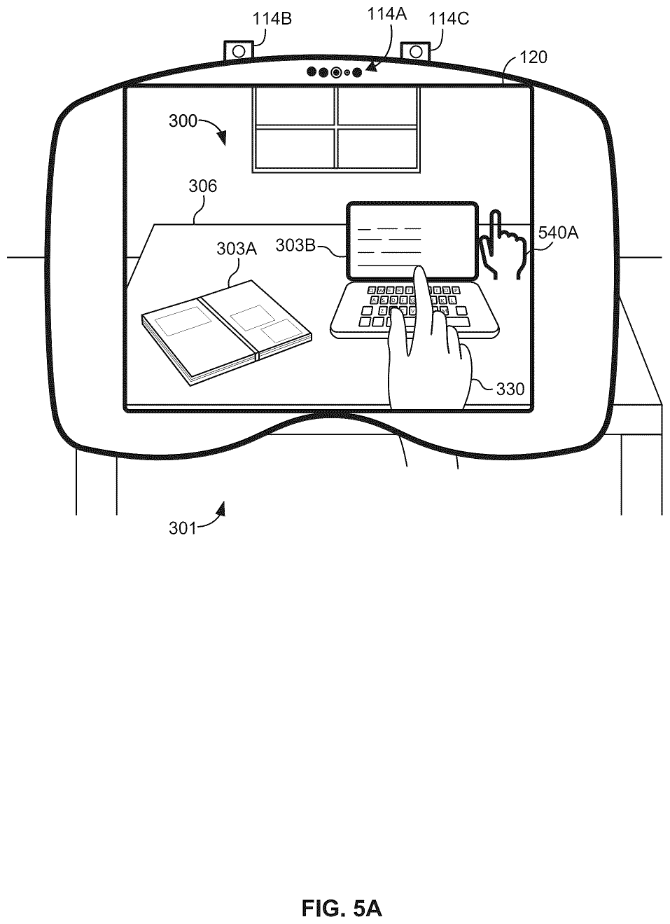

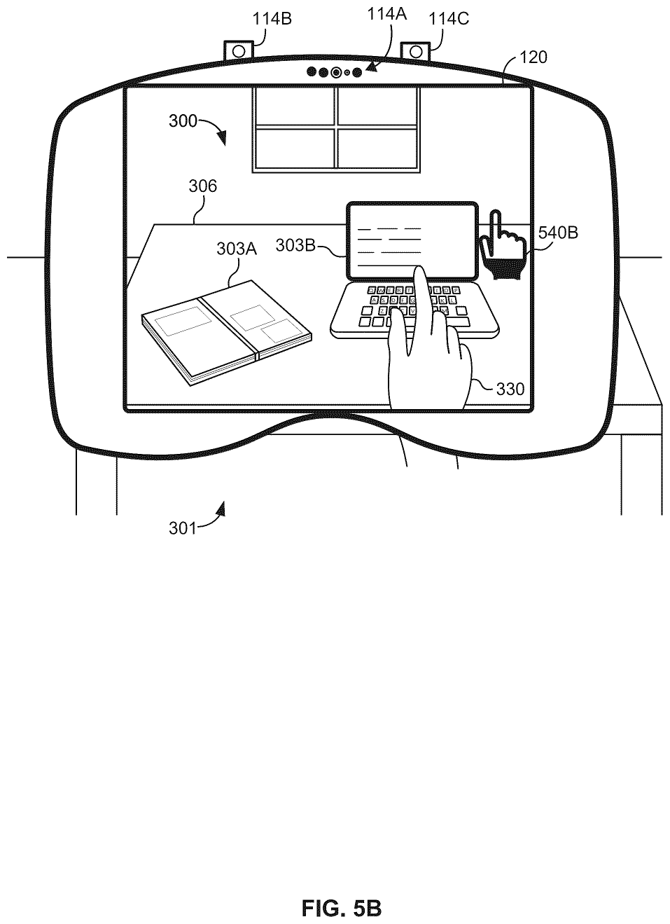

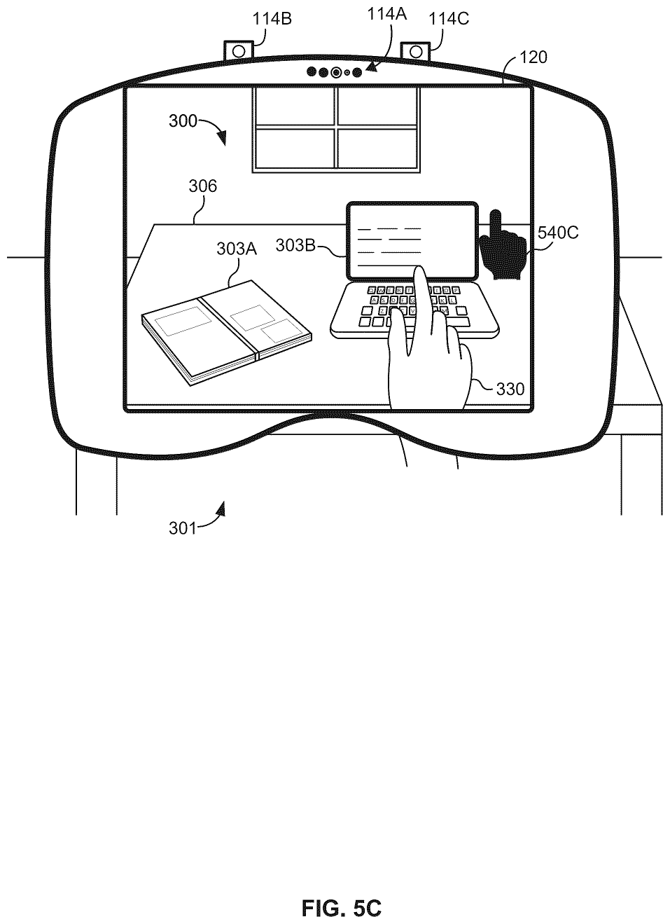

With reference to FIGS. 3B-3C, while detecting input 330 and presenting three-dimensional environment 300, electronic device 301 presents, in accordance with a determination that input 330 satisfies one or more criteria, feedback (e.g., in three-dimensional environment 300). In some examples, feedback can include one or more virtual objects, as described herein. For example, in some implementations, feedback includes one or more animated effects, user interface elements and/or graphical control elements, and/or the like, as described in further detail herein. For example, FIGS. 3B-3C illustrate an animated effect (e.g., a first animation or growth animation) that is presented to show growth, scaling, and/or changes in size (e.g., increasing a size of a dot or other indicator) of an object, according to examples of the disclosure. As another example, FIGS. 4A-4C and FIGS. 5A-5C illustrate an animation (e.g., a second animation or fill-up animation) that is presented to show filling or charging of an object (e.g., of a circle of a hand or of another closed geometry), according to examples of the disclosure.

Input 330 represents user input received or otherwise detected at electronic device 301. In some examples, input 330 can include an input gesture that is detected in connection with an object in the environment. For example, input 330 can include a pointing gesture directed at an object (also referred to herein as an “object-interaction gesture”). In this example, in response to detecting input 330 (e.g., including the pointing gesture directed at the object), the electronic device 301 presents information related to the object, as described herein. For example, in FIG. 3B the input 330 is a pointing gesture by an index finger of a user's hand (optionally also with the remaining fingers in a fist) pointing at object 303B (e.g., a computer or other physical object) in the environment. In some examples, the pointing gesture includes touching the object or being within a threshold distance of the object. Although input 330 is directed to a physical object, as shown in FIG. 3B, it is understood that the input could alternatively be applied and/or directed to a virtual object. Additional details of the pointing gesture (e.g., criteria to trigger feedback and/or criteria to trigger another action) are described in further detail herein. Additionally, although a pointing gesture is shown and described with reference to FIGS. 3A-3C, 4A-4C, and 5A-5C, it is understood that the input described herein is not so limited.

For example, input 330 can include touch input, touchless input, and/or the like. In some examples, touch inputs can include touch input gestures, including touch gestures such as tap input gestures, swipe input gestures, and/or the like. For example, input 330 can include touch input gestures that are made to and otherwise detected via an input device such as a touch sensitive surface (e.g., a touch sensor panel, trackpad, touch screen, etc.). Additionally or alternatively, input 330 can include touch input gestures such as object-interaction gestures, as described herein, that are made to and otherwise detected at a surface of a physical object in the environment, or through interaction with a virtual object when input 330 and the virtual object are positioned within or less than a threshold distance (e.g., zero) from each other (e.g., determined based on positions of the user's finger and/or hand and the virtual object).

In some examples, touchless inputs can include touchless input gestures, gaze input, motion input, and/or the like. Touchless inputs such as touchless input gestures can include any touchless or non-contact command invoked by the user (e.g., hand gestures such as pinch gestures, tapping gestures, open-hand gestures, pointing gestures (without contact), etc.; gaze; voice; etc.). In some examples, input 330 can include a touchless input gesture such as a pointing gesture positioned in the user's field of view, such as shown in FIGS. 3B-3C. As another example, touchless inputs such as gaze inputs can include one or more fixation points, gaze directions, points of focus of the user, and/or changes in the fixation point, gaze direction, and/or point of focus of the user, as described herein. As another example, touchless inputs such as motion inputs can include one or more measures of motion of electronic device 301 and/or movement of the user's hands or other body parts, as described herein. In some examples, the one or more measures of motion can include one or more measures of displacement of electronic device 301, including change(s) in position, speed, velocity, and/or acceleration of electronic device 301 and/or of the user's hands or other body parts.

Returning back to the example of FIGS. 3B-3C, while presenting three-dimensional environment 300, electronic device 301 determines whether or not input 330 satisfies one or more first criteria. The satisfaction of the one or more first criteria represent conditions by which electronic device 301 begins (and, in some examples, continues) to display the feedback, such as indicator 340A in FIG. 3B or indicator 340B in FIG. 3C, based on input 330. In some examples, in accordance with a determination that input 330 satisfies the one or more first criteria, electronic device 301 begins displaying the feedback. In some examples, the one or more first criteria correspond to performing the object-interaction gesture for a threshold period of time. In some examples, the threshold period of time can include a predetermined threshold period of time, as described in further detail below. For example, FIG. 3B shows the hand of the user performing an object-interaction gesture directed to object 303B that is detected for an input duration (represented by filled-in time bar 350) that is greater than or equal to a first time threshold 351 (also referred to as “first predetermined time threshold” or “first threshold period of time”). In some examples, in accordance with a determination that input 330 satisfies the one or more first criteria (e.g., in response to detecting the input duration for greater than or equal to the first time threshold 351), the electronic device 301 begins displaying the feedback (e.g., indicator 340A shown in FIG. 3B). In some examples, the first time threshold 351 can be between 50 ms and 400 ms. In some examples, the first time threshold 351 can be less than 150 ms. Additional details about the one or more first criteria are described below.

In some examples, electronic device 301 determines whether or not input 330 satisfies one or more second criteria. The satisfaction of the one or more second criteria represent conditions under which electronic device 301 begins displaying feedback (e.g., a virtual object, such as user interface element 342, including information associated with an object) based on input 330. In some examples, in accordance with a determination that input 330 satisfies the one or more second criteria, electronic device 301 begins displaying feedback (e.g., user interface element 342). For example, the one or more second criteria include a criterion that is satisfied in accordance with a determination that input 330 corresponds to an input gesture such as an object-interaction gesture that is performed for a duration equal to or greater than a threshold period of time. For example, FIG. 3C shows the hand of the user (corresponding to input 330) continuing to perform the object-interaction gesture with object 303B for an input duration (represented by filled-in time bar 350) that is greater than or equal to a second time threshold 352 (also referred to as “second predetermined time threshold” or “second threshold period of time”) at which point the electronic device 301. In accordance with a determination that the one or more second criteria are satisfied, including a criterion that is satisfied when (e.g., in response to detecting) input 330, corresponding to a predetermined object-interaction gesture, for an input duration greater than or equal to the second time threshold 352, the electronic device begins displaying feedback (e.g., user interface element 342). In some examples, the second time threshold 352 can be between 100 ms and 250 ms. In some examples, the second time threshold 352 can be less than 150 ms. Additional details about the one or more second criteria are described below.

In some examples, while the first criteria remain satisfied and until the second criteria are satisfied, the electronic device 301 can present an animation associated with the progress of the object-interaction gesture. For example, the feedback is represented by a virtual object (e.g., of a dot or other indicator) that is displayed with one or more animated effects to show growth of the virtual object. For example, when input 330 (e.g., including the object-interaction gesture) is maintained for a time period between the first time threshold 351 and the second time threshold 352, the indicator representing the feedback in FIGS. 3B-3C continues to grow, such as represented by the increase in size of indicator 340A from a first size, as shown in FIG. 3B, to a second size, as shown by indicator 340B in FIG. 3C. Although FIG. 3C shows feedback of indicator 340B together with user interface element 342, it is understood feedback of the indicator may be terminated (e.g., faded out, reversed, etc.) or otherwise shown upon reaching the second time threshold.

In some examples, electronic device 301 forgoes presenting the feedback, such as the indicator and/or the one or more animated effects of the indicator in accordance with a determination that input 330 fails to satisfy the one or more first criteria. For example, electronic device 301 forgoes presenting the indicator and forgoes presenting one or more animated effects in accordance with a determination that input 330 was not maintained for a duration exceeding a first threshold time period (e.g., corresponding to the first time threshold 351).

Additionally, after initiating the feedback and presenting the indicator 340A, electronic device 301 forgoes presenting or continuing the animated effect in accordance with one or more third criteria being satisfied. In some examples, these one or more third criteria are satisfied when the one or more first criteria, or a subset thereof, cease to be satisfied before satisfaction of the one or more second criteria. In some examples, the one or more third criteria are satisfied when a cancelation gesture or input is received. For example, in accordance with a determination that the one or more first criteria satisfied (e.g., including a criterion that is satisfied when input 330 including the object-interaction gesture is maintained for a duration corresponding to that of the first time period), the electronic device 301 begins presenting the animation indicating progress of the object-interaction gesture. In accordance with a determination that one or more third criteria are satisfied, the electronic device 301 forgoes presenting or continuing the animated effect. In some examples, the one or more third criteria are satisfied when electronic device 301 fails to detect input 330 between the first time threshold 351 and the second time threshold 352 (e.g., before satisfying the one or more second criteria. When the one or more third criteria are not satisfied, the indicator representing the feedback in FIGS. 3B-3C continues to grow. In accordance with a determination that the one or more second criteria are satisfied (e.g., including continuing satisfying the one or more first criteria, or a subset thereof, for a time period between the first time threshold 351 and the second time threshold 352), the animation continues to completion.

The above mentioned one or more first criteria and/or one or more second criteria include one or more criteria based on characteristics of input 330. In some examples, electronic device 301 detects (e.g., via one or more input devices) one or more characteristics of input 330 which are used for determining whether one or more of the criteria are satisfied. The one or more characteristics of input 330 can include any suitable characteristic, measure, property, and/or other attribute associated with input 330. In some examples, the one or more characteristics of input 330 can include input position, input duration, input stability (e.g., lack of motion), input type, input motion, object or point of interest, and/or the like.

In some examples, the one or more characteristics of input 330 can include input position, in which a measure of the input position of input 330 can include a measure of the position of input 330 (e.g., relative to the user, relative to a reference defined with respect to electronic device 301, etc.). For example, the one or more characteristics of input 330 can include the input position of input 330 in which the measure of the input position indicates the position of input 330 relative to the user (e.g., within or relative to the user's field of view, etc.). In some examples, the one or more characteristics of input 330 can include an input duration of input 330 corresponding to a measure of the duration of an interval during which input 330 is detected at electronic device 301.

In some examples, the one or more first criteria can include a criterion that is satisfied in response to detecting the hand within the user's field of view or within the field of view of electronic device 301, as shown in FIGS. 3B-3C. For example, the one or more first criteria can include a criterion that is satisfied in response to locating or otherwise detecting a position of input 330 at a position located within the user's field of view, such as shown in FIGS. 3B-3C.

In some examples, the one or more first criteria can include a criterion that is satisfied in accordance with a determination that a position of the gaze of the user corresponds to a position of input 330 and/or of the object of the object-interaction gesture. For example, the one or more first criteria can include a criterion that is satisfied in accordance with a determination that a position of the gaze of the user and a position of input 330 (or of the object) correspond to one another or otherwise substantially coincide (e.g., within a threshold distance). In some examples, the determination that the position of the gaze of the user and the position of input 330 correspond can be made in response to detecting the position of the gaze of the user at a position located within a predetermined threshold distance from the position at which input 330 is detected.

In some examples, the one or more first criteria can include a criterion that is satisfied in accordance with a determination that a position of an object (e.g., in three-dimensional environment 300 and or the physical environment) corresponds to a position of input 330. The object can include any object such as a virtual object in three-dimensional environment 300 and/or a physical object in the physical environment. For example, the one or more first criteria can include a criterion that is satisfied in accordance with a determination that a position of the object and a position of input 330 touch, correspond, overlap, or otherwise substantially coincide, as viewed from the perspective of the user. In some examples, the determination can be made in response to detecting the position of the object at a position located within a predetermined threshold distance from the position at which input 330 is detected.

In some examples, the one or more first criteria can include a criterion that is satisfied in accordance with a determination that a measure of stability of input 330 meets or exceeds a predetermined threshold (also referred to as “stability threshold”). The stability threshold can be defined to correspond to a measure of stability of input 330 that indicates user intent to provide an object-interaction input described herein (e.g., by holding the gesture at or otherwise corresponding to a position of a particular object for a duration that meets or exceeds the stability threshold). For example, the one or more first criteria can include a criterion that is satisfied in response to detecting a position of input 330 at positions located with a predetermined threshold space or volume (e.g., 1 mm, 2 mm, 3 mm, 5 mm, etc.) for a threshold time period (e.g., for 10 ms, 25 ms, 50 ms, 100 ms, 150 ms, 250 ms, 300 ms, 500 ms, etc.). In some examples, the measure of stability of input 330 meets or exceeds a predetermined threshold when the motion of input 330 is less than a threshold for a threshold period of time (e.g., speed, velocity, acceleration less than threshold speed, velocity, or acceleration threshold).

In some examples, the one or more first criteria can include a criterion that is satisfied in accordance with a determination that input 330 includes a gesture of a predetermined class or type. For example, the one or more first criteria can include a criterion that is satisfied in response to detecting input 330 including an object-interaction gesture. In some examples, the object-interaction gesture includes a pose of the hand and fingers corresponding to a pointing gesture with one pointing finger. In some examples, a particular finger is used for the pointing gesture (e.g., an index finger). In some examples, the pointing finger can be a different finger or multiple grouped fingers. In some examples, the remaining non-pointing fingers are folded (e.g., into a fist) to differentiate from the pointing finger. In some examples, the pose of the object-interaction gesture includes the extension of the arm such that the hand is a threshold distance from the user and/or that the hand is oriented palm down. In some examples, the gesture is determined to be of the predetermined input class or type by comparing the detected locations and orientations of portions of the hand with stored representations of locations and orientations of portions of the hand corresponding to predetermined input class or type, and determining that the gesture corresponding to predetermined input class or type in response to identifying a match greater than a predetermined threshold (e.g., match of 85%, 90%, 95%, 99%, etc.).

With reference to FIG. 3C, while detecting input 330 and presenting three-dimensional environment 300, electronic device 301 presents, based on input 330, one or more virtual objects. The one or more virtual objects can include user interface element 342 and/or user interface element 344. In some examples, user interface element 342 can include information associated with an object (e.g., an object to which input 330 is directed, such as object 303B as shown in FIGS. 3B-3C). The information can include encyclopedic information about the object and/or definitions of text associated with the object. The object can include, for example, a virtual object in three-dimensional environment 300 and/or a physical object (e.g., object 303A, object 303B, etc.) in physical environment 302 that is indicated by the object-interaction gesture. In some examples, user interface element 342 can be displayed to depict, represent, correspond to, or otherwise provide a graphical user interface display area with data representing content or information associated with a selectable object (e.g., in three-dimensional environment 300 and/or physical environment 302), as described herein. In some examples, user interface element 342 can include or otherwise correspond to a text box, pop-up window, and/or the like. In some examples, user interface element 344 is a selectable affordance to provide addition information beyond what is included in user interface element 342. In some examples, the user interface element is overlaid on a view of an object (e.g., the object of interest to which the gesture of the input is directed). In some examples, the user interface element is presented at the center of the field of view of the user or with a predetermined offset from the center of the field of view of user. In some examples, the user interface element is presented with an offset from the object (e.g., to avoid obstructing view of the object of interest to which the gesture of the input is directed).

In some examples, electronic device 301 determines whether or not input 330 satisfies one or more second criteria. When the one or more second criteria are satisfied, the electronic device terminates the animation (optionally using a second animation) and/or presents user interface element 342 including information corresponding to the object. After beginning displaying the feedback (after satisfying the one or more first criteria) and until the one or more second criteria are satisfied (without first satisfying the one or more third criteria), electronic device 301 continues displaying the feedback (e.g., indicator 340A and indicator 340B corresponding to a progress indicator) based on input 330. In some examples, the one or more second criteria can include criteria that are the same as the one or more first criteria (e.g., the second criteria are satisfied in response to continuing to detect characteristics of input 330 that satisfy the one or more first criteria after beginning displaying indicator 340A, as described herein). For example, the one or more second criteria can include a criterion that is satisfied in response to continuing to detect input 330, including the hand of the user within the user's field of view or within the field of view of electronic device 301, a criterion that is satisfied in response to determining that a measure of one or more characteristics of input 330 exceeds a first predetermined threshold 351, and/or the like. In some examples, the one or more second criteria can include a criterion that is satisfied in response to detecting input 330 for a time period exceeding the first predetermined threshold 351 and exceeding the second predetermined threshold 352 as shown in FIGS. 3B-3C. For example, FIGS. 3B-3C illustrate time bar 350, which is presented for illustration purposes (e.g., not necessarily presented in the three-dimensional environment 300). For example, FIG. 3B shows the input duration (represented by the filled in time bar 350) of input 330, which is greater than or equal to the first time threshold 351 and less than a second time threshold 352, without display of user interface element 342, whereas FIG. 3C shows the input duration is greater than or equal to the second time threshold 352, and thereby satisfies the one or more second criteria, causing electronic device 301 to display user interface element 342. A duration of the first time threshold 351 and/or the second time threshold 352 can be selected or otherwise implemented based on empirical data for improved user experience (e.g., long enough to reduce false positives, but short enough to enable to the user to obtain the feedback (e.g., user interface element 342). In some examples, the first time threshold and/or the second time threshold 352 can be user defined or based on historical behavior of the user. In some examples, one or more of the criteria (e.g., input duration, input stability, etc.) are user-defined or adapted to a user's historical behavior.

User interface element 342 and/or user interface element 344 can cease to be presented in the user interface after being presented. In some examples, user interface element can be terminated (e.g., cease being presented) in response to a user input to terminate presentation. For example, although not shown in FIG. 3C, user interface element 342 can include a button or other affordance selectable to terminate presentation of the user interface element. In some examples, electronic device 301 ceases to present the user interface without an express user input to an affordance. For example, termination of the presentation of user interface elements 342 and/or 344 can be based on a time period. In some examples, user interface element 342 can be displayed for a predetermined amount of time (e.g., for 1 second, 1.5 seconds, 2 seconds, 5 seconds, 15 seconds, etc.). In some examples, the amount of time a function of the amount of content included in user interface element 342, with more time allotted when the amount of content or type of content requires additional time to read or consume compared with less time allotted when the amount of the content or type of content requires less time to read or consume. Additionally or alternatively, gaze of the user can be used to terminate the input. For example, the user directing gaze at user interface element 342 indicates reading or consuming the contents of user interface element 342, and thereafter directing gaze away from user interface element 342 for some amount of time indicates that reading or consuming the contents of user interface element 342 are complete. Thus, gazing at the user interface element 342 can optionally increase the amount of time allotted to present user interface element 342 and/or gazing away from user interface element 342 can cause termination of the presentation of user interface element 342 or can trigger another predetermined amount of time (e.g., 50 ms, 100 ms, 200 ms, 250 ms, 500 ms, 1 s, etc.) after gazing away at which point to termination presentation of the user interface element 342. Additionally or alternatively, presentation of user interface element 342 is based on ceasing to receive input 330. For example, the electronic device can terminate presentation of the user interface immediately or a predetermined amount of time (e.g., 10 ms, 50 ms, 100 ms, 200 ms, 250 ms, etc.) after the electronic device detects that object-interaction gesture is concluded.

In some examples, electronic device 301 terminates presentation of user interface element 342 differently depending on the input used to cause presentation of user interface element 342. In some examples, electronic device 301 determines whether or not input 330 satisfies one or more fourth criteria, different from the one or more third criteria (satisfied in response to termination of the animation effect, such as in ceasing to display and/or termination of indicator 340A-340B before completion of the animation effect), different from the one or more second criteria (satisfied to present user interface element 342), and different from the one or more first criteria (satisfied to present the animation effect, such as indicator 340A-340B). For example, electronic device 301 can be configured to determine whether or not input 330 satisfies the one or more fourth criteria after or in response to determining that input 330 satisfies the one or more first criteria and the one or more second criteria, as described herein.

The one or more fourth criteria correspond to performing the object-interaction gesture for a duration equal to or greater than a threshold period of time (e.g., optionally including one or more of the first and second criteria). For example, FIG. 3C illustrates a third time threshold 353 (e.g., a predetermined time threshold). When the object-interaction gesture is maintained for the second time threshold 352, but is terminated before the third time threshold 353 (e.g., one or more fourth criteria are not satisfied), termination of presentation of the user interface element 342 can be based on a predetermined period of time. As described herein, the predetermined period of time can be computed, for example, from the point of satisfaction of the one or more second criteria (e.g., from second time threshold 352), from the initiation of display of user interface element 342, from the termination of input 330, or from when the direction of gaze is away from user interface element 342. Additionally, as described herein, in some examples, the duration of the predetermined period of time can be a function of the amount and/or type of content in user interface element 342. In contrast, when the object-interaction gesture is maintained for the second time threshold 352 and for the third time threshold 353 (e.g., one or more fourth criteria are satisfied), termination of presentation of the user interface element 342 can be based on conclusion of the object-interaction gesture. For example, termination of presentation of the user interface element 342 is in response to ceasing to receive input 330 after exceeding third time threshold 353. For example, the electronic device can terminate presentation of the user interface immediately or a predetermined amount of time (e.g., 10 ms, 50 ms, 100 ms, 200 ms, 250 ms, etc.) after the electronic device detects that object-interaction gesture is concluded.

Referring back to the animation effects described herein, electronic device 301 presents feedback based on the one or more characteristics of input 330. In some examples, feedback can include one or more virtual objects optionally including one or more animated effects. For example, as shown in FIGS. 3B-3C, the animated effect can be a growth animation presented based on the one or more characteristics of input 330 to provide a visual indicator showing the status and/or progress of as the object-interaction gesture described herein. In some examples, the one or more animated effects can include computer-generated imagery (CGI), moving images, still images, and/or the like. In some examples, animated effect shows growth of an indicator 340A-340B indicating progress. It is understood that progress can be indicated in other ways, including but not limited to, a progress bar, a progress ring, a progress dot, or another progress icon. In some examples, electronic device displays the feedback including the animation effect at a position located within the user's field of view (e.g., within a threshold distance and/or angle of the user's gaze or user's hand). In some examples, the position of at which the feedback is displayed is a fixed location (e.g., the same region of the one or more displays). Optionally, the depth of the indicator is fixed or is a function of the distance to the object targeted by the object interaction gesture. In some examples, the position is at a center of the user's field of view, optionally with a vertical offset from center (e.g., lower than the center, e.g., +/−5 degrees relative to the center of the user's field of view). In some examples, the position at which the feedback is displayed can be chosen based on historical user behavior, a detected size of pointing object performing input 330 (e.g., corresponding to a size of the user's hand or finger or handheld/worn input device), an input position of input 330 (e.g., corresponding to the position of the user's hand or finger or handheld/worn input device), and/or the like.

Although growth of the indicator (e.g., a sequence of rendering the indicator with different sizes) is used to indicate progress of the object-interaction gestures (e.g., the duration of input 330), in some examples, electronic device 301 displays feedback using additional or alternative visual characteristics of the animation. For example, additionally or alternatively, the indicator can fade into view by animating an increase in opacity corresponding to progress. Additionally or alternatively, ceasing to present the feedback of the indicator (e.g., corresponding to the completion of or abortion of the object-interaction gesture) can be accompanied by a second animation effect. The second animation effect can be similar to or different from the first animation effect. In some examples, ceasing to present the feedback of the indicator is achieved with a second animation effect that includes shrinking the indicator over time and/or fading out the indicator (e.g., reducing opacity, increasing transparency) over time. In some examples, the second animation effect reverses the first animation effect, but at a relatively faster rate for the second animation effect compared with the first animation effect.

In some examples, electronic device 301 can be configured to dismiss, terminate, or otherwise forgo completing presenting the feedback of the indicator (e.g., indicator 340A-340B), including one or more animated effects (e.g., the first animated effect), when the one or more first third criteria are satisfied (e.g., the one or more first criteria, or a subset thereof, are no longer satisfied between the first time threshold 351 and the second time threshold 352). For example, electronic device 301 can be configured to terminate feedback in accordance with a determination that input 330 fails to satisfy the one or more criteria, such as the one or more first criteria or a subset thereof, as described herein, between the first time threshold 351 and the second time threshold 352. In some examples, electronic device 301 can be configured to terminate feedback in response to ceasing to detect a cancelation input instead of the object-interaction input while presenting the first animated effect. For example, electronic device 301 can be configured to terminate the presentation of the first animation effect by displaying a termination effect (e.g., fade-out, etc.).

In some examples, the termination effect can provide an indication of a cancellation status and can be different than the animation effect (e.g., second animation effect) presented when the first animation is completed to provide an indication of a completion status. For example, the interval over which the indicator associated with the first animation ceases to be presented can be shorter for termination of the object-interaction gesture (e.g., satisfying the one or more third criteria, failing to satisfy the one or more first criteria) compared with the interval for the completion of the animation (e.g., the duration between the first time threshold and the second time threshold).

Returning to termination of the user interface elements 342 and/or 344, in some examples, in accordance with a determination that one or more fourth criteria are satisfied, including a criterion that is satisfied when a duration of input 330 (e.g., including the object-interaction gesture) exceeds the third time threshold 353, different from the first or second predetermined threshold, the user interface element can be displayed over a predetermined time period following termination of the input. In some examples, the one or more fourth criteria can include a criterion that is satisfied when the display or output duration of user interface element 342 exceeds a predetermined display threshold. In some examples, in accordance with a determination that the one or more fourth criteria are satisfied, electronic device 301 displays user interface element 342 based on the input duration of input 330, including terminating the display of user interface element 342 upon termination of input 330.

In some examples, electronic device 301 forgoes displaying feedback when the user exhibits signs of inattention or a lack of attention, such as in the user's head, hands, and/or eyes being simultaneously directed to and/or otherwise targeting different objects. For example, the one or more first criteria, the one or more second criteria, and/or the one or more third criteria include one or more gating criteria by which to avoid initiating feedback and/or display of the user interface when unintended by the user. For example, electronic device 301 forgoes displaying feedback in accordance with a determination that the one or more gating criteria are satisfied, including a criterion that is satisfied in accordance with a determination that a difference in position between a first location at which input 330 is directed at a first time period (e.g., determined in response to detecting a gaze of the user directed at the first location) and a second location at which input 330 is directed at a second time period (e.g., determined in response to detecting a pointing gesture of the user directed at the second location) exceeds a predetermined threshold (e.g., 0.25 meters, 0.5 meters, etc.). In this example, the first time period and the second time period correspond, coincide, overlap, or otherwise at least partially occur simultaneously. Additionally or alternatively, the one or more gating criteria include a criterion that is satisfied in accordance with a determination that the first time period and the second time period occur within a predetermined threshold time period of each other (e.g., the first time period and/or the second time period occur within 2 seconds of each other, the second time period begins within 2 seconds after the first time period ends, etc.).

Additionally or alternatively, in some examples, the one or more gating criteria includes a criterion that is satisfied when a duration of input 330 is less than the first predetermined threshold 351, such that electronic device 301 forgoes displaying the feedback until the duration of the input 330 exceeds the first predetermined threshold 351. Additionally or alternatively, in some examples, in accordance with a determination that hand tracking indicates too much movement of the hand/finger (e.g., above a threshold amount of movement, in terms of position, speed, velocity and/or acceleration), gaze tracking indicates too much movement of the eyes (e.g., above a threshold amount of movement, in terms of position, speed, velocity and/or acceleration), and/or motion tracking indicates too much movement of the head (e.g., above a threshold amount of movement, in terms of position, speed, velocity and/or acceleration), electronic device 301 forgoes displaying the feedback.

FIGS. 4A-4C and FIGS. 5A-5C illustrate other example operations of an electronic device including presenting feedback based on input directed at an object in a three-dimensional environment according to some examples of the disclosure. As shown, FIGS. 4A-4C and FIGS. 5A-5C illustrate electronic device 301 in a physical environment while presenting feedback in three-dimensional environment 300, as described herein. The physical environment can include any physical environment (e.g., in which electronic device 301 is located) such as the physical environment shown and described with reference to FIG. 1. As shown, electronic device 301 presents three-dimensional environment 300 in connection with the user's view of the physical environment, including displaying feedback based on input 330. In some examples, the feedback can include animated effect for an indicator 440A-440C, as shown in FIGS. 4A-4C or for an indicator 540A-540C, as shown in FIGS. 5A-5C.

The feedback including animation of the indicator 440A-440C or including animation of the indicator 540A-540C can be presented, maintained, terminated, and/or completed in a similar manner as described with respect to FIGS. 3A-3C, the details of which are not repeated here for brevity. However, unlike the growth animation of the indicator shown in FIG. 3B-3C, in FIGS. 4A-4C and FIGS. 5A-5C, electronic device 301 displays feedback, including a fill-up animated effect for indictor 440A-440C or indicator 540A-504C, culminating with the display of a user interface element 442 (and/or user interface element 444) when the one or more second criteria are satisfied. For each of illustration, the user interface elements (e.g., corresponding to user interface elements 442 and/or user interface element 444) are omitted in FIG. 5C for ease of illustration. For example, the displayed feedback can include one or more unfilled virtual objects subject to a fill-up animation. For example, the animation includes presenting an unfilled virtual object and filling-up the unfilled object as the animation (and the object-interaction gesture) progresses. For example, indicator 440A in FIG. 4A shows relatively less fill, indicator 440B shows relatively more fill, and indicator 440C shows the virtual object completely filled. Additionally or alternatively, in some examples, after showing indicator 440C as completely filled, the computer system ceases displaying indicator 440C while continuing to display user interface element 442 (and/or user interface element 444). Likewise, indicator 540A in FIG. 5A shows relatively less fill (no fill), indicator 540B shows relatively more fill, and indicator 540C shows the virtual object completely filled. FIGS. 4A-4C illustrates a closed circle, but the shape of the indicator is not so limited. In some examples, the indicator is a closed boundary, a circular object, a square object, a rectangular object, a non-geometric object and/or the like. In some examples, the indicator has the shape of a hand as shown in FIG. 5A-5C.

In some examples, the fill-up animations described herein can include a duration (also referred to herein as “fill duration”). In some examples, the duration of the fill-up animation is between 50 millisecond and 750 milliseconds. In some examples, the duration of the fill-up animation is between 100 millisecond and 300 milliseconds. In some examples, the fill-up animation can include a fill duration of between 250 milliseconds to 500 milliseconds. In some examples, the fill-up animations described herein can be displayed for a duration corresponding to a duration of the first time threshold 351. Additionally or alternatively, the fill-up animations described herein can be displayed for a duration corresponding to a duration of the second time threshold 352. The fill duration can be implemented based on empirical data for improved user experience (e.g., long enough to reduce false positives and provide meaningful guidance to the user, but short enough to enable to the user to obtain the feedback and results of the operation (e.g., user interface elements 342, 442)).

In some examples, electronic device 301 can be configured to present the feedback progress in a linear manner (e.g., proportional with duration). In some examples, electronic device 301 can be configured to present the feedback progress in a non-linear manner such that the fill rate appears to increase (e.g., the fill rate speeds up) or decrease (e.g., the fill rate slows down) over the duration of input 330. For example, the fill rate can increase or decrease linearly or at a constant rate over the duration of input 330. In some examples, electronic device 301 can be configured to present progress feedback such that the fill rate appears constant over the duration of input 330. Advantageously, dynamically adjusting the fill rate enables presenting progress feedback such that the user has time for decision-making (e.g., to cancel an operation before the progress indicator is complete, etc.).

In some examples, electronic device 301 can be configured to present progress feedback, including animated effects, with a fill rate based on the one or more characteristics of input 330, such as the input position, object of interest (e.g., object 303B), and/or the like. For example, electronic device 301 can be configured to present progress feedback with a first fill rate based on a first distance between the input position of input 330 and object 303B. In this example, electronic device 301 can be configured to present progress feedback with a second fill rate, greater than the first fill rate, based on a second distance, less than the first distance, between the input position of input 330 and object 303B. Additionally or alternatively, in some examples, the fill rate can increase as the object-interaction gesture is maintained because the longer the object-interaction gesture is maintained satisfying the one or more first criteria the higher the confidence that the object-interaction gesture and associated operation are desired (and to improve the user experience by executing the associated operation sooner).

In some examples, the indicator of progress shown in FIGS. 5A-5C 540 can be displayed based on the handedness or chirality of the user (e.g., left-handedness, right-handedness, etc.). For example, electronic device 301 can be configured to display the indicator 540A-540C based on input 330, including detecting the input type of 330, and classifying the input type into a left- or right-handedness class of inputs. In some examples, electronic device 301 displays the indicator 540A-540C, to correspond and/or match with the handedness of the user, as shown in FIGS. 5A-5C (e.g., right handed input 330 with right handed indicator 540A-540C).

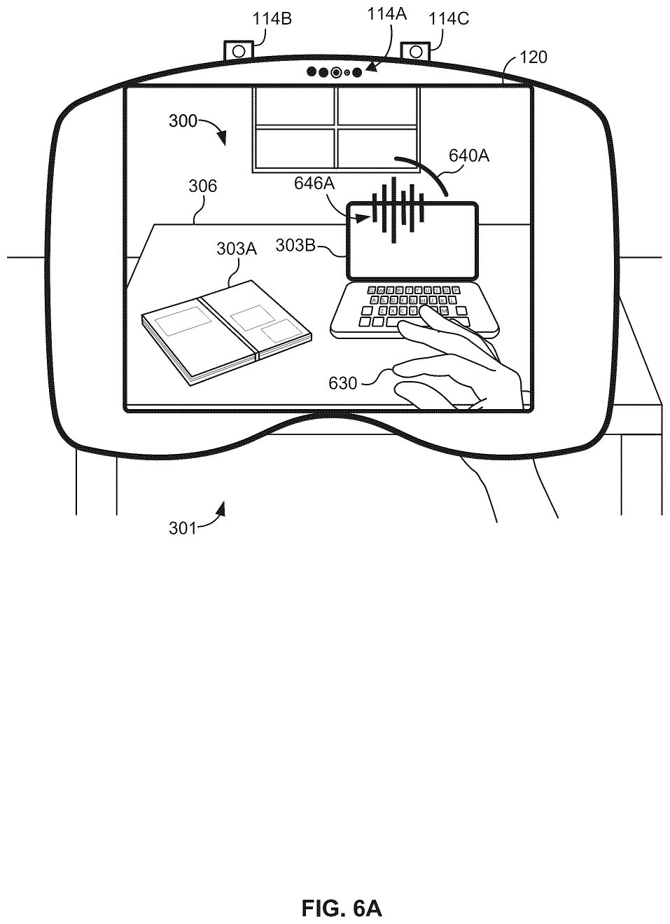

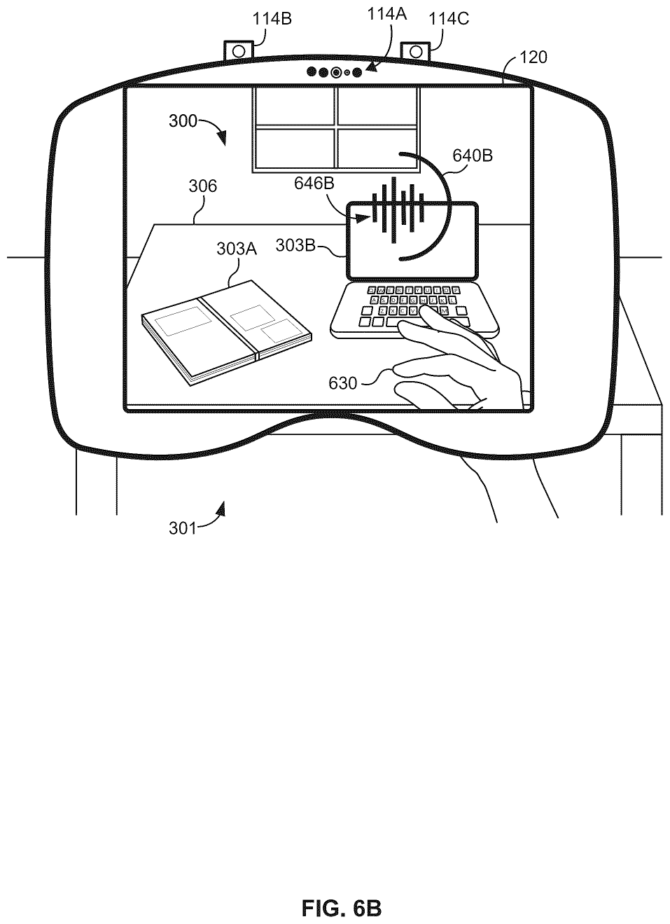

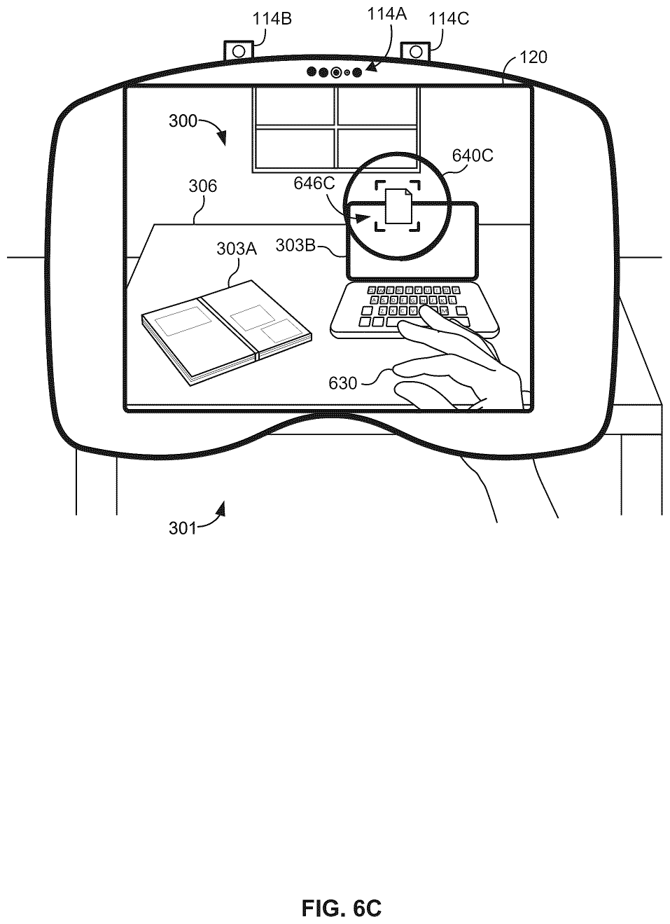

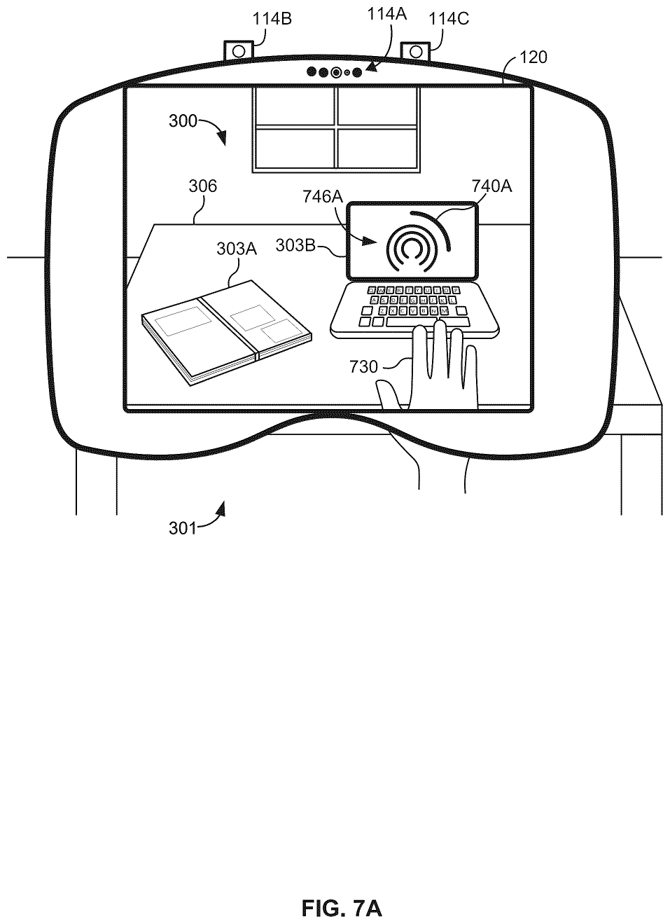

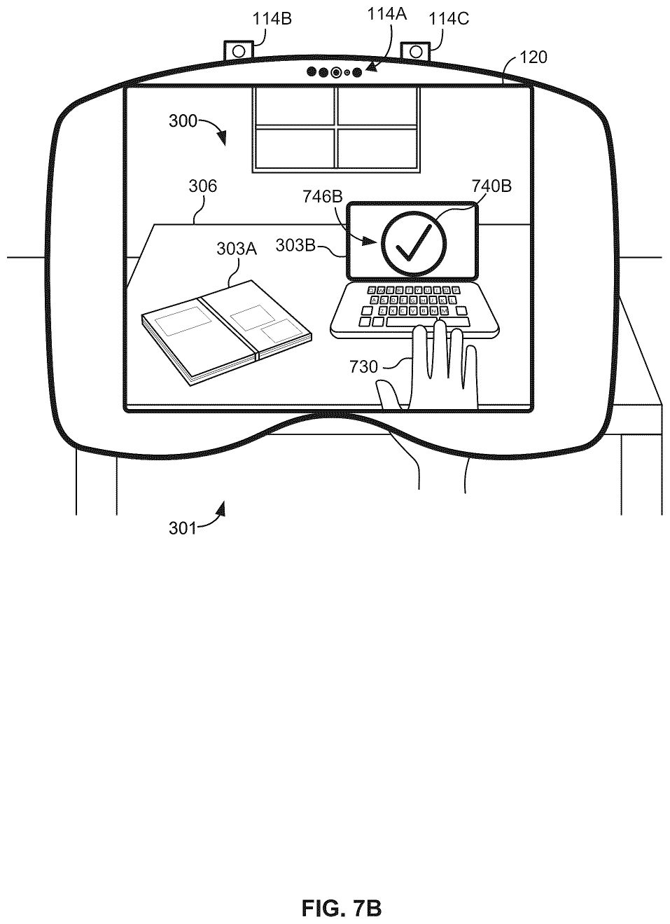

FIGS. 3A-3C, 4A-4C, and 5A-5C primarily focused on an object-interaction gesture (e.g., a pointing gesture) to cause presentation of a user interface element with information associated with the targeted object, and feedback including an animation effect and/or progress indicator. Other gestures can be implemented to perform other actions, such as the gestures to select content (as in FIGS. 6A-6C) and transfer content (as in FIG. 7A-7B), which are optionally accompanied by an animation effect and/or progress indicator. FIGS. 6A-6C illustrate electronic device 301 in a physical environment in which electronic device 301 is presenting feedback in three-dimensional environment 300. The physical environment can include any physical environment (e.g., in which electronic device 301 is located) such as the physical environment shown and described with reference to FIG. 1. In some examples, the feedback can include one or more virtual objects corresponding to one or more animated effects and/or user interface elements, such as animated effect applied to progress ring 640A-640C, as shown in FIGS. 6A-6C.

In some examples, progress ring 640A-640C can represent a progress indicator of selection (or extraction) of content. For example, the progress ring grows circumferentially until the ring is shown as closed in FIG. 6C. Selection (or extraction) can correspond to selecting/extracting text from a physical page (e.g., from object 303A), selecting/extracting a two-dimensional or three-dimensional representation of an object, or selecting/extracting a file (e.g., document, media, etc.) from a computer storage device (e.g., displayed on a screen or playing from speakers of an electronic device (e.g., object 303B). In some examples, a visual indicator of progress can alternatively be represented using a progress bar or other progress indicators such as described herein with respect to earlier figures.

Additionally or alternatively, a visual indicator of progress and of the operation is indicated using an icon (or progress icon). As shown in FIG. 6A-6B, while performing the selection (or extraction) of the content, an icon 646A-646B can present a glyph representative of the selection/extraction operation in progress. As shown in FIG. 6C, when the selection (or extraction) of the content is complete, the icon 646C can present a glyph representative of the extracted content (e.g., a document, etc.) and completion of selection/extraction operation. Although FIG. 6C shows a closed progress ring 640C together with the icon 646C representative of the extracted content, in some examples, the closed progress ring 640C ceases to be displayed as part of an animation of the change of the icon from the progress icon to the completion icon.

Additionally or alternatively, in some examples, icon 646C can be selectable to present a virtual representation of the extracted content in the three-dimensional environment. In some examples, electronic device 301 automatically presents the extracted content as the virtual representation (and optionally ceases to display icon 646C) automatically. In some examples, displaying the virtual representation includes at least partially superimposing the virtual representation over the object in three-dimensional environment 300 (e.g., displays a virtual representation of the extracted content overlaid over the physical screen of object 303A using the electronic device's one or more displays.

The feedback including animation of the progress indicator (e.g., ring 640A-640C) and/or the icon 646A-646C) can be presented (e.g., when one or more first criteria are satisfied), maintained (e.g., while the one or more first criteria are satisfied and before one or more second criteria are satisfied), terminated (when the one or more first criteria cease to be satisfied), and/or completed (e.g., when the one or more second criteria are satisfied) in a similar manner as described with respect to FIGS. 3A-3C, the details of which are not repeated here for brevity, though the one or more first criteria and/or the one or more second criteria may be different. For example, input 630 can be different than input 330. For example, input 330 was primarily described as a pointing gesture (e.g., with stability, duration, etc.), input 630 can include a pinch gesture optionally accompanied by movement away from the targeted object and toward the user/electronic device while maintaining the pinch gestures. In some examples, the pinch gesture is a two finger pinch (e.g., index and thumb) and the objected is targeted with gaze or by the pointing direction of the two fingers. In some examples, the gesture is a pinch with more than two fingers (e.g., a five finger pinch), and the object is targeted with gaze, by the pointing direction of the multiple fingers, or by the pointing direction of the hand before initiating the multi-finger pinch gesture. In some examples, the one or more first criteria include an input duration that is equal to or greater than a first time threshold. In some examples, after initiating the display of the progress indicator, progress can progress as the pinch gesture is maintained and as a function of movement away from the object and toward the user (e.g., a pulling gesture while maintaining the pinch). The one or more second criteria can include a criterion that the amount of movement exceeds a movement threshold (e.g., a threshold distance). Thus, the progress indicator can provide for discoverability of the functionality and an indication of progress so the user understands the movement needs to continue to trigger the operation.

FIGS. 7A-7B illustrate another example of operating of an electronic device including presenting feedback based on input directed at an object in a three-dimensional environment according to some examples of the disclosure. As shown, FIGS. 7A-7B illustrate electronic device 301 in a physical environment while presenting feedback in three-dimensional environment 300. The physical environment can include any physical environment (e.g., in which electronic device 301 is located) such as the physical environment shown and described with reference to FIG. 1. As shown, electronic device 301 presents three-dimensional environment 300 for viewing by the user including displaying feedback based on input 730, as shown in FIGS. 7A-7B.

In some examples, the feedback can include one or more virtual objects corresponding to one or more animated effects such as animated effect applied to progress ring 740A-740B, as shown in FIGS. 7A-7B. Progress ring 640A-640C can represents a progress indicator of transfer of content from the electronic device 301 to another electronic device (e.g., object 303B). For example, the progress ring grows circumferentially until the ring is shown as closed in FIG. 7B. Transfer of content can correspond to sending a file (e.g., document, media, etc.) to an electronic device (e.g., computer, media player, or storage device, etc.). In some examples, a visual indicator of progress can alternatively be represented using a progress bar or other progress indicators such as described herein with respect to earlier figures.

Additionally or alternatively, a visual indicator of progress and of the operation is indicated using an icon (or progress icon). As shown in FIG. 6A, while performing the transfer of the content, an icon 746A can present a glyph representative of the transfer operation in progress. As shown in FIG. 7B, when the transfer of the content is complete, the icon 746B can present a glyph representative of the completion of the transfer operation. Although FIG. 7B shows a closed progress ring 740B together with the icon 746B representative of the completed transfer of content, in some examples, the closed progress ring 740B ceases to be displayed as part of an animation of the change of the icon from the progress icon to the completion icon.

The feedback including animation of the progress indicator (e.g., ring 740A-740B) and/or the icon 746A-746B) can be presented, maintained, terminated, and/or completed in a manner similar to that described with respect to FIGS. 3A-3C, above, the details of which are not repeated here for brevity. For example, the feedback including animation of the progress indicator can be presented when one or more first criteria are satisfied. In some examples, the feedback including animation of the progress indicator is maintained until the one or more second criteria are satisfied (e.g., after the one or more first criteria are satisfied and before one or more second criteria are satisfied). In some examples, the feedback including the animation of the progress indicator is terminated when on or more third criteria are satisfied. In some examples, these one or more third criteria are satisfied when the one or more first criteria, or a subset thereof, cease to be satisfied before satisfaction of the one or more second criteria. In some examples, the feedback including animation of the progress indicator is completed when the one or more second criteria are satisfied.

In some examples, the one or more first criteria and/or the one or more second criteria may be different. For example, input 730 can be different than input 330 or 630. For example, input 330 was primarily described as a pointing gesture (e.g., with stability, duration, etc.) and input 630 was primarily described as a pinch gesture optionally accompanied by movement, whereas input 730 can include pointing with a palm or an open hand optionally including opening of a fist and/or accompanied by movement toward the targeted object and away from the user/electronic device while opening the hand or maintaining the open hand with extended fingers. In some examples, the objected is targeted with gaze and/or by the pointing direction of the palm/open hand. In some examples, the one or more first criteria include an input duration that is equal to or greater than a first time threshold. In some examples, after initiating the display of the progress indicator, progress can progress as the pinch gesture is maintained and/or as a function of movement toward the object and away from the user. The one or more second criteria can include a criterion that the amount of movement exceeds a movement threshold (e.g., a threshold distance). Thus, the progress indicator can provide for discoverability of the functionality and an indication of progress so the user understands the input needs to continue to trigger the operation.

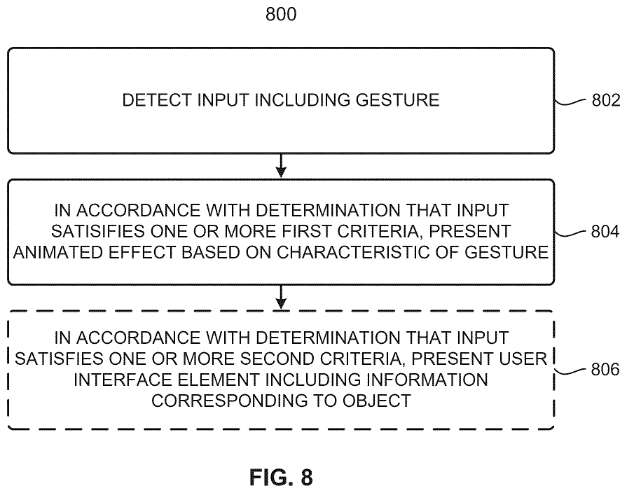

FIG. 8 is a flow chart illustrating an example method for presenting feedback based on input directed at an object (e.g., an object-interaction gesture) according to some examples of the disclosure. Method 800 is implemented at an electronic device (e.g., electronic device 101, 201, 301) in communication with one or more displays (e.g., display(s) 214) and one or more input devices (e.g., sensor(s) 212, 210, 204), as described herein. In some examples, the electronic device presents the feedback described herein in a three-dimensional environment, such as an XR environment (e.g., three-dimensional environment 300, 400, 500, 600, and/or 700). The feedback can include the feedback (e.g., indicators and animated effects) described in FIGS. 3A-3C, 4A-4C, 5A-5C, 6A-6C, and 7A-7B.

In some examples, at 802, the electronic device detects, via the one or more input devices, input including a gesture (e.g., an object-interaction gesture). For example, the electronic device can detect one or more characteristics of the input including the gesture, as described with reference to input 330 of FIGS. 3A-3C. In some examples, the object-interaction gesture includes a finger pointing at the object. In some examples, the object-interaction gesture is performed while the finger (or other input device) is touching an object or within a threshold distance of the object and directed at the object for a threshold period of time. In some examples, the object-interaction gesture includes a pose including an index finger (or other finger) of a hand optionally also with the remaining fingers in a fist (e.g., similar to the illustrated virtual hand user interface object in FIGS. 5A-5C). In some examples, the object-interaction gesture includes stability of the gesture (e.g., with less than a threshold movement while performing the gestures). In some examples, the object-interaction gesture includes the input being performed within the user's field of view.

In some examples, at 804, the electronic device presents, via the one or more displays, a first animated effect in the three-dimensional environment based on a characteristic of the gesture while detecting the input including the gesture and in accordance with a determination that the input satisfies one or more first criteria. Progress of the first animated effect can indicate progress of the characteristic of the gesture. For example, the electronic device presents the three-dimensional environment using optical see-through or video passthrough techniques as described herein present the three-dimensional environment and to present the animated effect based on the input. For example, the animated effect optionally includes a growth animation (as shown in FIGS. 3B-3C), a fill-up animation (as shown in FIGS. 4A-4C, 5A-5C), a progress ring animation (as shown in FIGS. 6A-6C, 7A-7B), and/or an icon transformation animation (as shown in FIGS. 6A-6C, 7A-7B). The growth animation, fill-up animation, or progress ring animation can provide a visual indicator to maintain the input gesture and/or a visual indicator of how long to maintain the input gesture in order to complete an operation.

When the one or more criteria are not satisfied, the electronic device forgoes presenting the first animated effect.

In some examples, maintaining the input so as to satisfy one or more second criteria (e.g., for the duration of the first animated effect) causes display of a user interface element. The user interface element optionally includes encyclopedic information, definitions, etc. In such examples, at 806, the electronic device presents, via the one or more displays, the user interface element including information corresponding to the object in accordance with the input satisfying one or more second criteria. The electronic device can also cease to display the first animation or can present a second animated effect that terminates the first animated effect (e.g., fading out the indicator at the end of the first animated effect or reversing the first animated effect) when the one or more second criteria are satisfied.

In some examples, in accordance with a determination that the input has ceased before satisfying the one or more second criteria, the electronic device terminates the first animated effect without completing the first animated effect. For example, the termination can include immediately ceasing presenting the indicator associated with the animated effect, fading out the indicator associated with the animated effect, or reversing the first animated effect. The termination of the first animated effect before satisfying the one or more second criteria can be different than the termination of the first animated effect upon satisfying the one or more second criteria (e.g., terminate faster, more abruptly, etc.).

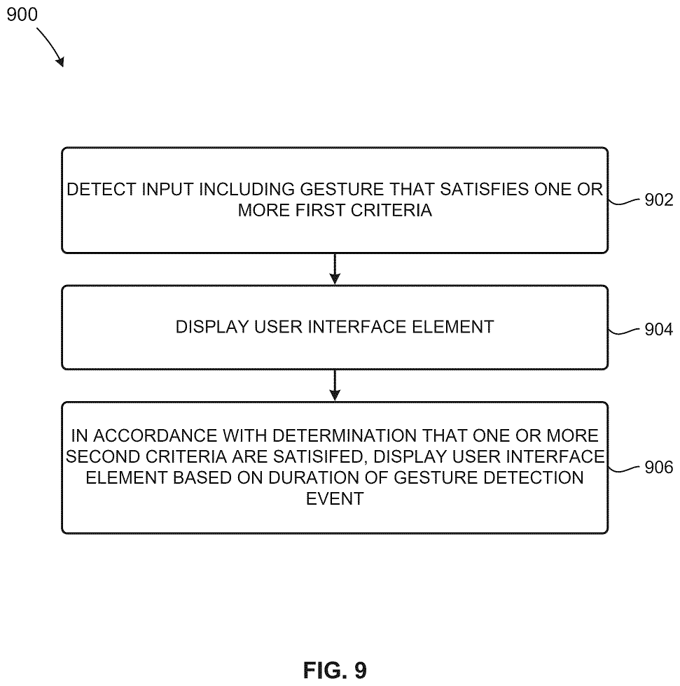

FIG. 9 is a flow chart illustrating an example method for presenting and terminating a user interface element based on input according to some examples of the disclosure. Method 900 is implemented at an electronic device (e.g., electronic device 101, 201, 301) in communication with one or more displays and one or more output devices, as described herein. In some examples, the electronic device presents a user interface (e.g., described at 806 in method 800) based on inputs described herein in a three-dimensional environment. The user interface can be terminated based on a characteristic of the input (e.g., the duration that the input is held after satisfying the one or more second criteria or after displaying the user interface).

In some examples, at 902, the electronic device detects, via the one or more input devices, input including a gesture directed at an object (e.g., an object-interaction gesture).

At 904, in response to detecting the gesture, and in accordance with a determination that the input satisfies one or more criteria (e.g., including at least the one or more second criteria described with respect to FIG. 8 at 806), the electronic device presents, via the one or more displays, a user interface element in the three-dimensional environment. For example, the electronic device can be configured to display the user interface element in the three-dimensional environment, as described herein (e.g., user interface element 342, 442). The user interface element includes information associated with the object, as described herein.

In some examples, termination of the presentation of the user interface element depends on the duration of the input. For example, the object interaction gesture described herein (e.g., including a finger of the user of the electronic device within a threshold distance of the object and pointing at the object) can be released after satisfying the one or more criteria or alternatively may be maintained for at least or more than a predetermined threshold (that is greater than the predetermined threshold required to present the user interface). In the former instance, the user interface can be dismissed after a predetermined period of time, whereas in the latter instance the user interface can be dismissed after ceasing the object-interaction gesture. Referring back to the time bar 350 of FIG. 3C, performing the object-interaction gesture for an input duration that is greater than or equal to a second time threshold 352 causes the electronic device to begin displaying user interface element 342. Performing the object-interaction gesture for an input duration that is less than a third time threshold 353 can cause the user interface element 342 to be dismissed after a threshold period of time. Performing the object-interaction gesture for an input duration that is greater than or equal to a third time threshold 353 can cause the user interface element 342 to be dismissed after ceasing performing the object-interaction gesture.

For example, at 906, while presenting the user interface element in accordance with a determination that the input including the gesture satisfies one or more second criteria, the electronic device terminates the presentation of the user interface element in accordance with termination of the input including the gesture (e.g., in response to detecting termination of the object interaction gesture). Alternatively, in accordance with a determination that the input including the gesture fails to satisfy the one or more second criteria, the electronic device terminates the presentation of the user interface element in accordance with a predetermined time period. In some examples, the predetermined time period can be measured from the termination of the input including the object-interaction gesture. In some examples, the predetermined time period is measured from the presentation of the user interface element.

It is understood that method 800 and method 900, respectively, are examples and that more, fewer, or different operations can be performed in the same or in a different order. Additionally, the operations in method 800 and/or method 900, as respectively described above, are, optionally, implemented by running one or more functional modules in an information processing apparatus such as general-purpose processors (e.g., as described with respect to FIG. 2) or application specific chips, and/or by other components of FIG. 2. Furthermore, in some examples, each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantageously, method 800 and/or method 900 enable systems to provide information associated with an object using an object interaction gesture. The object interaction gesture improves the user experience by reducing the number of inputs required to otherwise provide this information by navigating user interface menus or providing hardware controls. In some examples, by simply pointing at or touching an object using the object interaction gesture can trigger the presentation of this information. Additionally, method 800 and/or method 900 enable systems to provide feedback (e.g., animated effects) and dismiss feedback in a three-dimensional environment based on measures of characteristics of input from a user. This feedback allows the user to easily and intuitively discover the object-interaction gesture and/or understand the status, functionality, rate of progress and/or other information about the gesture or associated operations in the three-dimensional environments, thereby enabling more effective interactions, operations, and use of the systems by users. In some examples, the adaptive provision of feedback can be configured to adjust to historical user behaviors based on past inputs, advantageously enabling more effective interactions and operations by the user that require less input from the user and less power to execute.

Therefore, according to the above, some examples of the disclosure are directed to systems and methods for providing feedback. The method can be performed at an electronic device in communication with one or more displays and one or more input devices. In some examples, the electronic device can detect, via the one or more input devices, an input including a gesture directed at an object in a three-dimensional environment. Additionally or alternatively to one or more of the examples disclosed above, in some examples, the input can include a touch input gesture, a touchless input gesture, a gaze of a user of the electronic device, or motion of the electronic device. Additionally or alternatively to one or more of the examples disclosed above, in some examples, the electronic device can, while detecting the input including the gesture and in accordance with a determination that the input satisfies one or more first criteria, present, via the one or more displays, a first animated effect based on a characteristic of the gesture in the three-dimensional environment, wherein progress of the first animated effect indicates progress of the characteristic of the gesture.

Additionally or alternatively to one or more of the examples disclosed above, in some examples, in accordance with a determination that the input fails to satisfy the one or more first criteria, the electronic device can forgo presenting the first animated effect. Additionally or alternatively to one or more of the examples disclosed above, in some examples, while detecting the input including the gesture and in accordance with a determination that the input satisfies one or more second criteria, the electronic device can present, via the one or more displays, a second animated effect that terminates the first animated effect. Additionally or alternatively to one or more of the examples disclosed above, in some examples, in accordance with the input satisfying the one or more second criteria, presenting, via the one or more displays, a user interface element including information corresponding to the object.

Additionally or alternatively to one or more of the examples disclosed above, in some examples, in accordance with a determination that the input fails to satisfy the one or more second criteria, terminating the first animated effect without completing the first animated effect. Additionally or alternatively to one or more of the examples disclosed above, in some examples, the one or more first criteria include a criterion that is satisfied in response to detecting, via the one or more input devices, the input within a threshold distance of an object and directed at the object. Additionally or alternatively to one or more of the examples disclosed above, in some examples, presenting the first animated effect includes presenting, via the one or more displays, a virtual object and the progress of the first animated effect includes a filling animation of the virtual object or a growth animation of the virtual object.

Additionally or alternatively to one or more of the examples disclosed above, in some examples, the virtual object includes a virtual hand, a closed boundary, or a circular object. Additionally or alternatively to one or more of the examples disclosed above, in some examples, a handedness of the virtual hand matches a handedness of a hand of the user performing the gesture. Additionally or alternatively to one or more of the examples disclosed above, in some examples, presenting the second animated effect includes fading out the virtual object after the filling animation or the growth animation. Additionally or alternatively to one or more of the examples disclosed above, in some examples, presenting the second animated effect includes reversing the growth animation at a faster rate than the growth animation.

Some examples of the disclosure are directed to systems and methods for providing feedback. The method can be performed at an electronic device in communication with one or more displays and one or more input devices. In some examples, the electronic device can detect, via the one or more input devices, an input including a gesture directed at an object. Additionally or alternatively to one or more of the examples disclosed above, in some examples, in accordance with a determination that the input satisfies one or more first criteria, the electronic device can present, via the one or more displays, a user interface element in a three-dimensional environment. Additionally or alternatively to one or more of the examples disclosed above, in some examples, the user interface element includes information associated with the object.

Additionally or alternatively to one or more of the examples disclosed above, in some examples, while presenting the user interface element and in accordance with a determination that the input including the gesture satisfies one or more second criteria, terminating the display presentation of the user interface element in accordance with termination of the input including the gesture. Additionally or alternatively to one or more of the examples disclosed above, in some examples, while presenting the user interface element and in accordance with a determination that the input fails to satisfy the one or more second criteria, terminating the presentation of the user interface element in accordance with a predetermined time period. Additionally or alternatively to one or more of the examples disclosed above, in some examples, the input includes a gesture including a finger of the user of the electronic device within a threshold distance of the object and pointing at the object. Additionally or alternatively to one or more of the examples disclosed above, in some examples, the one or more second criteria include a criterion that is satisfied in response to detecting an input duration of the input for a duration exceeding a predetermined threshold.

Additionally or alternatively to one or more of the examples disclosed above, in some examples, the predetermined threshold is greater than a second time threshold of the one or more first criteria. Additionally or alternatively to one or more of the examples disclosed above, in some examples, terminating the presentation of the user interface element in accordance with the predetermined time period includes terminating the presentation of the user interface element after presenting the user interface element for the predetermined time period. Additionally or alternatively to one or more of the examples disclosed above, in some examples, terminating the presentation of the user interface element in accordance with the predetermined time period includes terminating the presentation of the user interface element after the predetermined time period following the termination of the input.

Additionally or alternatively to one or more of the examples disclosed above, in some examples, terminating the presentation of the user interface element in accordance with the termination of the input including the gesture includes terminating the presentation of the user interface element in response to detecting termination of the input.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more displays and one or more input devices:
detecting, via the one or more input devices, an input including a gesture directed at an object;
in accordance with a determination that the input satisfies one or more first criteria, presenting, via the one or more displays, a user interface element in a three-dimensional environment, wherein the user interface element includes information associated with the object; and
while presenting the user interface element:
in accordance with a determination that the input including the gesture satisfies one or more second criteria, terminating the presentation of the user interface element in accordance with termination of the input including the gesture; and
in accordance with a determination that the input including the gesture fails to satisfy the one or more second criteria, terminating the presentation of the user interface element in accordance with a predetermined time period.

2. The method of claim 1, wherein the gesture includes a finger of a user of the electronic device within a threshold distance of the object and pointing at the object.

3. The method of claim 1, wherein the one or more second criteria include a criterion that is satisfied in response to detecting an input duration of the input including the gesture for a duration exceeding a predetermined threshold.

4. The method of claim 3, wherein the predetermined threshold is greater than a second time threshold of the one or more first criteria.

5. The method of claim 1, wherein terminating the presentation of the user interface element in accordance with the predetermined time period includes terminating the presentation of the user interface element after presenting the user interface element for the predetermined time period.

6. The method of claim 1, wherein terminating the presentation of the user interface element in accordance with the predetermined time period includes terminating the presentation of the user interface element after the predetermined time period following the termination of the input including the gesture.

7. The method of claim 1, wherein terminating the presentation of the user interface element in accordance with the termination of the input including the gesture includes terminating the presentation of the user interface element in response to detecting termination of the input.

8. An electronic device, comprising:
one or more displays;
one or more input devices;
one or more processors;
memory; and
one or more programs, wherein the one or more programs are stored in the memory and configured to be executed by the one or more processors, the one or more programs including instructions for:
detecting, via the one or more input devices, an input including a gesture directed at an object;
in accordance with a determination that the input satisfies one or more first criteria, presenting, via the one or more displays, a user interface element in a three-dimensional environment, wherein the user interface element includes information associated with the object; and
while presenting the user interface element:
in accordance with a determination that the input including the gesture satisfies one or more second criteria, terminating the presentation of the user interface element in accordance with termination of the input including the gesture; and
in accordance with a determination that the input including the gesture fails to satisfy the one or more second criteria, terminating the presentation of the user interface element in accordance with a predetermined time period.

9. The electronic device of claim 8, wherein the gesture includes a finger of a user of the electronic device within a threshold distance of the object and pointing at the object.

10. The electronic device of claim 8, wherein the one or more second criteria include a criterion that is satisfied in response to detecting an input duration of the input including the gesture for a duration exceeding a predetermined threshold.

11. The electronic device of claim 10, wherein the predetermined threshold is greater than a second time threshold of the one or more first criteria.

12. The electronic device of claim 8, wherein terminating the presentation of the user interface element in accordance with the predetermined time period includes terminating the presentation of the user interface element after presenting the user interface element for the predetermined time period.

13. The electronic device of claim 8, wherein terminating the presentation of the user interface element in accordance with the predetermined time period includes terminating the presentation of the user interface element after the predetermined time period following the termination of the input including the gesture.

14. The electronic device of claim 8, wherein terminating the presentation of the user interface element in accordance with the termination of the input including the gesture includes terminating the presentation of the user interface element in response to detecting termination of the input.

15. A non-transitory computer-readable storage medium storing one or more programs, the one or more programs comprising instructions, which, when executed by an electronic device with one or more displays and one or more input devices, cause the electronic device to perform:
detecting, via the one or more input devices, an input including a gesture directed at an object;
in accordance with a determination that the input satisfies one or more first criteria, presenting, via the one or more displays, a user interface element in a three-dimensional environment, wherein the user interface element includes information associated with the object; and
while presenting the user interface element:
in accordance with a determination that the input including the gesture satisfies one or more second criteria, terminating the presentation of the user interface element in accordance with termination of the input including the gesture; and
in accordance with a determination that the input including the gesture fails to satisfy the one or more second criteria, terminating the presentation of the user interface element in accordance with a predetermined time period.

16. The non-transitory computer-readable storage medium of claim 15, wherein the gesture includes a finger of a user of the electronic device within a threshold distance of the object and pointing at the object.

17. The non-transitory computer-readable storage medium of claim 15, wherein the one or more second criteria include a criterion that is satisfied in response to detecting an input duration of the input including the gesture for a duration exceeding a predetermined threshold.

18. The non-transitory computer-readable storage medium of claim 17, wherein the predetermined threshold is greater than a second time threshold of the one or more first criteria.

19. The non-transitory computer-readable storage medium of claim 15, wherein terminating the presentation of the user interface element in accordance with the predetermined time period includes terminating the presentation of the user interface element after presenting the user interface element for the predetermined time period.

20. The non-transitory computer-readable storage medium of claim 15, wherein terminating the presentation of the user interface element in accordance with the predetermined time period includes terminating the presentation of the user interface element after the predetermined time period following the termination of the input including the gesture.

21. The non-transitory computer-readable storage medium of claim 15, wherein terminating the presentation of the user interface element in accordance with the termination of the input including the gesture includes terminating the presentation of the user interface element in response to detecting termination of the input.
